(19) United States
(12) Patent Application Publication
(10) Pub. No.: US 2006/0197851 A1
(43) Pub. Date: Sep. 7, 2006

(54) Positioning a subject with respect to a background scene in a digital camera

(76) Inventor: Paul Vlahos, Tarzana, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/074,480

(22) Filed: Mar. 7, 2005

(51) Int. Cl. H04N 5/262

(52) U.S. Cl. 348/239

(57) ABSTRACT

A method of positioning an image of a subject, placed before a selected backing, to a desired position with respect to an image of a background scene appearing on a camera view screen, using a digital camera. An image is observed on the camera's view screen and at least one of the subject and the camera are physically positioned to place the subject's image at the desired position with respect to the image of said background scene. An image of the positioned subject in front of said background scene is captured in the camera. A composite image of the subject and the background scene is then formed. Additional subjects may be captured and composited using the prior composite as the background scene for each added subject.

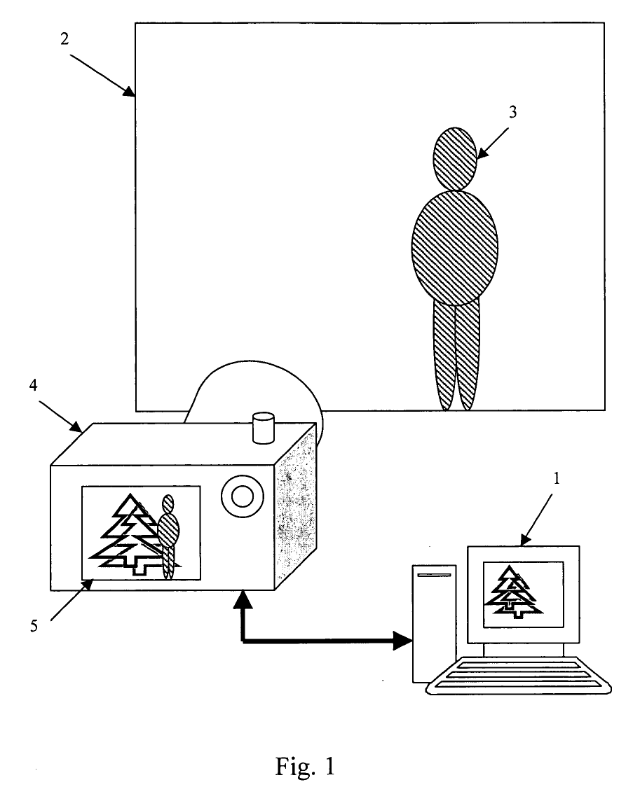

### BACKGROUND

This invention relates to the pre-positioning of multiple images in a still digital camera for subsequent compositing onto the image of a background scene.

Blue screen image compositing technology makes possible the generation of a number of special video effects such as believable giants, or shrunken people as in the movie, “Honey I Shrunk The Kids”.

Another useful effect uses multiple image layers. Subjects are photographed separately and composited one at a time to become a multilayer composite image. This process allows one actor to play several roles in the same scene.

Not all subjects must be people. If one of the subjects, in a multilayer composite image is a wall of flames, then previously composited subjects will be seen to be behind the flames, while subsequent composited subjects will be seen to be on the camera side. To be effective, those subjects behind the fire should be made smaller, while those subjects on the camera side of the fire are enlarged to provide distance perspective.

Although the blue screen image compositing process was developed for motion picture and television productions, it works equally well for still pictures. Another compositing technique employs the detection of luminance levels, but is not as successful as the blue screen process. Even a double exposure has been used to create a composite image to achieve an artistic effect in still photography.

With the advent of the digital camera, many of its users would like to achieve some of these special effects for themselves, without requiring the skills of an image processing specialist.

### SUMMARY OF THE INVENTION

This invention permits an operator of a digital still camera to position a high resolution image of a subject, with respect to the image of a background scene, in the camera instead of a computer. A low resolution composite image of the subject and background scene permits the operator to physically position the subject with respect to the background scene, while observing the composite image on the camera view screen.

### BRIEF DESCRIPTION OF THE DRAWING

The FIGURE is a diagram showing the functions required for a digital camera to preview and generate the layers of a multilayer composite image.

### DETAILED DESCRIPTION OF THE INVENTION

The positioning of a subject's image is explained by the following example and the FIGURE. Assume an individual wishes to take a picture of a group of seven friends at some exotic location. He finds the cost of transportation to be prohibitive, and getting them all together at one time is not practical. His solution to this problem is to use a digital camera (4) to photograph each friend separately as each becomes available. Using prior art techniques, the images would then be downloaded into a computer for compositing onto a background scene.

A multilayer composite image, however, requires all of the subject images to be properly positioned with respect to each other and to the background scene. If the subjects are positioned in the computer, an image editing program such as Adobe Photoshop®, or similar program is required. To avoid this complex operation, one can pre-position the subjects in a digital camera when the camera is equipped with a simple compositing program using, for example, a chroma-key technique. Creating such a simple compositing program for use in present generation digital cameras is well within the abilities of persons skilled in the art.

The first step is to photograph the exotic background scene, or transfer a suitable background scene from an external source such as a computer (1) to the camera.

The second step is to select a backing (2) to place behind the subject. While a plain wall of almost any color may be used, extracting a good matte is readily achieved if the wall color is not used in the subject's wardrobe and is compatible with the requirements of the compositing program used by the camera. A matte is a black silhouette of the subject against a clear field that permits the subject to be placed over the background scene without creating a double exposure.

To prevent cluttering the composite image being viewed on the camera view screen by lighting fixtures, doors, and furniture lying inside the image frame, a windows feature in the compositing program is used to mask-out or crop these objects. Each of the window's four edges can be positioned to avoid all unwanted objects in the viewed image, thus effectively extending the backing to the edge of the image frame. This window function permits the use of a relatively small backing extending only a short distance beyond the subject. For example, modern digital cameras typically include a four-position switch with a select button. A window, that is a rectangular outline, can be moved up/down and left/right using the four-position switch. Once in the desired position, typically surrounding the subject, but excluding the rest of the image, a button can be pressed to fix the window at the desired location. If the window is too small or too large, the window can also be resized using the four-position switch so that the window encloses the foreground subject while excluding everything else.

The position and size of each window is recorded as part of the subject image data at the moment the foreground subject is captured. This window placement and size data defines the window when the subject layers are composited in computer 1. Having the window size and placement data and layer number of the pre-positioned subjects permits image compositing with little or no human intervention.

The third step is to photograph the first subject (3). The compositing program in the camera (4) composites the image of the subject over the image of the background scene, thus forming a composite image on the camera view screen (5).

The compositing program in the camera need not actually composite the high resolution images of the subject and background scene. The number of pixels comprising an image on a camera's view screen is a small fraction of the number of pixels comprising a high resolution digital image in the camera. What is being composited during the subject positioning process are low resolution replicas extracted from high resolution images, at the resolution required by the camera view screen.

The relatively small number of pixels comprising the image on the view screen, and a simple compositing program, permits rapid replacement of the composite image to keep it current as the subject's position is being changed.

As the operator observes the camera view screen (5), the background scene will be fixed on the camera view screen, but the image of the first subject is free to follow the camera's movements. Pointing the camera is the simplest way to position the subject up, down, left or right, with respect to a background image. The size of the subject is adjusted by physically moving the subject to a new position toward or away from the camera. Within its limits, a size change can also be made by adjusting the camera's zoom lens.

Having properly positioned the subject with respect to the background scene, the operator presses the “Take” button on the camera. At this instant, the composite image on the camera view screen is captured. The composite image on the view screen now contains the first subject positioned on the background scene. This image is stored since it will become the background scene when photographing the second subject.

Simultaneously, the pre-positioned high resolution image of the first subject against its original backing is captured and stored. It is coded as subject layer #1.

When the second subject is available, he is placed against the backing. The composite image of the first subject and background is recalled from memory and becomes the background scene for the second subject. The camera operator positions the second subject to place his image alongside the image of the first subject, keeping in mind to leave space for the remaining five subjects.

Being satisfied that the second subject is properly placed, the “Take” button is touched. At this moment the second subject also becomes part of the background scene, and is stored. It will become the background scene for the third subject. Simultaneously the pre-positioned high resolution image of the second subject against the backing is stored in camera memory, and coded as subject layer #2. The backing used behind the second and later subjects need not be the same backing used for subject #1. A backing is often chosen because its color does not match any of the colors in the subject's wardrobe, thus assuring the extraction of a good matte.

The above process is repeated for each subject until all seven subjects have been positioned and photographed. The seven high resolution pre-positioned subjects, each in front of a selected backing, are downloaded to a computer for compositing with the selected background scene. If the background scene originated in the camera, then the original, high resolution background scene is also downloaded to the computer. At this point the low resolution composite image of the seven subjects may be discarded.

An added advantage of positioning the layers of a multilayer composite image in the camera instead of a computer, is the uniform resolution of all layers with respect to each other. When sizing is done in the computer, those images that are enlarged will have a lower resolution than those images not enlarged.

Many image compositing programs will composite one or more image layers with little or no operator intervention if the images have been pre-positioned. A compositing program such as the ULTIMATTE “KnockOut” (U.S. Pat. No. 6,134,346) will produce a flawless high quality composite image at the resolution of the images provided. There are essentially no limits to the number of layers in a multilayer composite image. One may composite a single layer or a hundred or more layers, as needed.

Having positioned a subject in the camera, it is also possible to make a high resolution composite image in the camera as well. However, to composite a high resolution image over a background scene takes a substantial amount of time to perform the data processing with the limited processing power currently available for inclusion in a small digital camera. However, as the cost of memory decreases and processing power increases, performing a high resolution composite image in the camera is possible since the necessary technology already exists.

All elements of this invention, including digital image compositing, are well known to those skilled in generating visual special effects for motion picture and television productions, and graphic arts. U.S. Pat. No. 6,134,346 is an example of a digital software image compositing program. There are at least a dozen manufacturers making image compositing devices, or their equivalent in software. Many of these programs will extract a suitable matte if an appropriate backing has been selected, and uniformly illuminated.

A simple digital compositing program using, for example, a chroma-key technique, because of its minimal processing requirement, can be incorporated into the design of almost any sized digital camera including a cell phone, personal pocket sized digital camera and the larger professional digital cameras. A mode switch on the camera permits camera function buttons to be used as compositing function buttons when positioning a subject's image. The compositing program and camera control functions can occupy common digital data processing and image storage chips.

1-15. (canceled)

16. A method for positioning an image of a subject, placed before a selected backing, to a desired position with respect to an image of a background scene, in a digital camera, comprising:
a) observing a composite image on said camera's view screen as at least one of said subject and said camera are physically positioned to place said subject's image at said desired position with respect to the image of said background scene,
b) capturing in said camera an image of said positioned subject in front of said selected backing.

17. The method of claim 16 in which said digital camera includes a program that extracts the subject from its backing before said subject is composited with said background scene image for display on said camera view screen.

18. The method of claim 16 in which said composite image is captured in said camera when said subject image is in said desired image position.

19. The method of claim 16, in which a number of subject images may be positioned with respect to said background scene, to form a multilayer composite image by using a composite image of a previously positioned subject as the background scene when positioning a current subject.

20. The method of claim 16 in which each said captured image, of said subject in front of said selected backing, is given a sequence number with respect to its position in said sequence.

21. The method of claim 16 in which areas outside said selected backing area, within said camera view, are masked.

22. The method of claim 21 in which a position of a window comprising said mask is recorded for subsequent use when said subject is composited at its full resolution.

23. The method of claim 16 in which said composite image is a series of composite images to permit an observer of said view screen to see the result of physically moving one of said subject and digital camera in the process of positioning said subject to a desired position with respect to said background scene.

24. The method of claim 16 in which said composite image as seen on said camera view screen is formed from the two components comprising a composite image, each of which are at the resolution of said view screen, before being composited.

25. The method of claim 17 in which the quality of said composite images formed in said camera, is limited by the subject extraction ability of said camera's compositing program.

26. The method of claim 16 in which at least one of said camera and said subject is physically repositioned toward or away from each other to adjust the image size of said subject.

27. The method of claim 16 in which a focal length of said camera may be varied to adjust said subject image size.

28. The method of claim 16 in which said digital camera is equipped with a mode switch to permit the camera's control buttons to be used for said image positioning.

29. The method of claim 17 in which said program uses data processing and image storage chips of said camera.

30. The method of claim 16 in which said composite image is created using a means for acquiring a double exposure.
